(19) United States
(12) Patent Application Publication
(10) Pub. No.: US 2002/0102965 A1
(43) Pub. Date: Aug. 1, 2002

(54) Wireless information exchange and management system and method

(76) Inventors: Michael Mandahl, Stockholm (SE); Jan Morath, Hasselby (SE); Christer Gustafsson, Stockholm (SE)

Correspondence Address: OSTROLENK FABER GERB & SOFFEN, 1180 AVENUE OF THE AMERICAS, NEW YORK, NY, 100368403

(21) Appl. No.: 09/770,887

(22) Filed: Jan. 26, 2001

(51) Int. Cl. H04M 11/10

(52) U.S. Cl. 455/412; 455/414; 455/557

(57) ABSTRACT

A wireless network service connects to current desktop enabled systems and provides mobile users with access to desktop applications. The service connects to applications and databases storing user information and converts information from the application and database formats to a wireless format, and vice-versa. Mobile users connect to an internet through wireless devices, and send and receive information from the wireless network service. The mobile user can manipulate information contained in familiar applications and databases from a mobile platform, and submit requests for network operations, such as printing and faxing. Familiar programs such as electronic messaging, calendars and contact lists are all accessible on a mobile basis. The wireless network service provides standard interface connections to easily install with existing programs and systems. The service uses platform independent protocols with standard interface connections to permit flexible and simple upgrades or modifications.

### BACKGROUND OF THE INVENTION

1. Field of the Invention

The present invention relates generally to providing information to individuals or groups through wireless connections. More specifically, the present invention provides a system and method that permits users to receive, manipulate and send information over wireless connections, based on information managed at a fixed location related to an organization.

2. Description of the Related Prior Art

The present business enterprise and organization environment relies heavily on information disseminated in electronic format. E-mail, voice mail and web page content are just a few well known means for providing users access to needed information related to operations within the enterprise or organization. Groups or individuals within an organization typically desire or need to share information to reach their various goals and accomplish assigned tasks. A variety of software and systems are available to assist individuals and groups in the management of information and information flow between various entities.

With the advent of wireless or mobile communications, many organizations have attempted to increase productivity and efficiency for individuals or groups that may be remote from an organization center, such as occurs when traveling. The promise of wireless communication has encouraged many organizations to share information among individuals and groups in a format suitable for wireless access. For example, an individual may have a mobile telephone equipped to receive and send e-mail messages in relation to performing organization related tasks. The individual may communicate and organize information through a variety of media including audio and text.

Mobile telephones and Personal Digital Assistants (PDAs) may also be wireless enabled to receive information available typically on an Internet web page. These wireless devices receive web page like content transmitted using Wireless Application Protocol (WAP) and containing eXtensible Markup Language (XML) directives for information display. Accordingly, an individual can access an Internet web page featuring WAP enabled content that provides organization information generally, or specific to the individual.

Within an organization, electronically stored information is typically shared based on the needs of individuals or groups. For example, individuals within one department may need access to information and applications that are irrelevant to any other department's operation. Accordingly, when the need arises to transmit information between individuals and groups, a variety of organization based platforms can be used. Examples of means for sharing electronically stored data include e-mail, instant messaging, voice mail, calendar appointments, database content, web page content, facsimile transmission and remote printing. Typically, these types of information sharing require a substantial support infrastructure, and consume large amounts of processing resources.

If an individual requires access to information while located remotely from the organization, their options may be limited to the simple examples above, e-mail and web page access. Because of the resources required to process the more sophisticated techniques of information sharing, a mobile user is unlikely to participate significantly using a mobile phone or PDA.

### SUMMARY OF THE INVENTION

In view of the above discussion, it is an object of the present invention to overcome the drawbacks present in the state of the art.

Briefly stated, according to the present invention, there is provided a wireless network service that connects to current desktop enabled systems and provides mobile users with access to desktop applications. The service connects to applications and databases storing user information and converts information from the application and database formats to a wireless format, and vice-versa. Mobile users connect to an internet through wireless devices, and send and receive information from the wireless network service. The mobile user can manipulate information contained in familiar applications and databases from a mobile platform, and submit requests for network operations, such as printing and faxing. Familiar programs such as electronic messaging, calendars and contact lists are all accessible on a mobile basis. The wireless network service provides standard interface connections to easily install with existing programs and systems. The service uses platform independent protocols with standard interface connections to permit flexible and simple upgrades or modifications.

According to an embodiment of the present invention, there is provided a wireless information exchange system, comprising: a wireless device, a network connectable to the wireless device, an information processor connectable to the network, the processor and the wireless device operable to exchange wireless format information through the network, a database accessible by the processor and the processor can store and retrieve information in the database thereby providing the wireless device with access to database information.

According to another embodiment of the present invention, there is provided a method of exchanging wireless information, comprising: providing a connection between a wireless device and an information processor having access to information stored in a database, exchanging wireless format information between the wireless device and the processor, converting information between a database format and a wireless format and exchanging information between the processor and the database.

According to another embodiment of the present invention, there is provided a processor operable to execute a program code from a storage memory, the program code comprising: a first code segment executable to provide a connection between a wireless device and an information processor having access to information stored in a database, a second code segment executable to exchange wireless format information between the wireless device and the processor, a third code segment executable to convert information between a database format and a wireless format and a fourth code segment executable to exchange information between the processor and the database.

According to another embodiment of the present invention, there is provided a computer readable media containing a program code executable to provide a wireless information exchange, the program code comprising: a first code segment executable to provide a connection between a wireless device and an information processor having access to information stored in a database, a second code segment executable to exchange wireless format information between the wireless device and the processor, a third code segment executable to convert information between a database format and a wireless format and a fourth code segment executable to exchange information between the processor and the database.

According to another embodiment of the present invention, there is provided a computer network for deploying a wireless information exchange, comprising: a wireless device, a network connectable to the wireless device, an information processor connectable to the network, the processor and the wireless device operable to exchange wireless format information through the network, a database accessible by the processor and the processor can store and retrieve information in the database thereby providing the wireless device with access to database information.

### BRIEF DESCRIPTION OF THE DRAWINGS

The above, and other objects, features and advantages of the present invention, will become apparent from the following description read in conjunction with the accompanying drawings, in which:

FIG. 1 is a connectivity diagram showing various components and their interaction according to the present invention;

FIG. 2 is a diagram of user interface levels for data access and presentation according to the present invention; and

FIGS. 3 is a diagram of the conceptual structure of the system according to the present invention.

### DETAILED DESCRIPTION OF THE PREFERRED EMBODIMENTS

The present invention provides a system and method for collective wireless access to operational information by members of an organization. The system permits individuals and groups belonging to the organization to efficiently exchange information with applications and each other on a variety of levels while at remote locations. The system is easily applied to existing systems to take advantage of prior resource investments. As systems or applications are upgraded, the system can be simply modified and expanded to meet the needs of new applications.

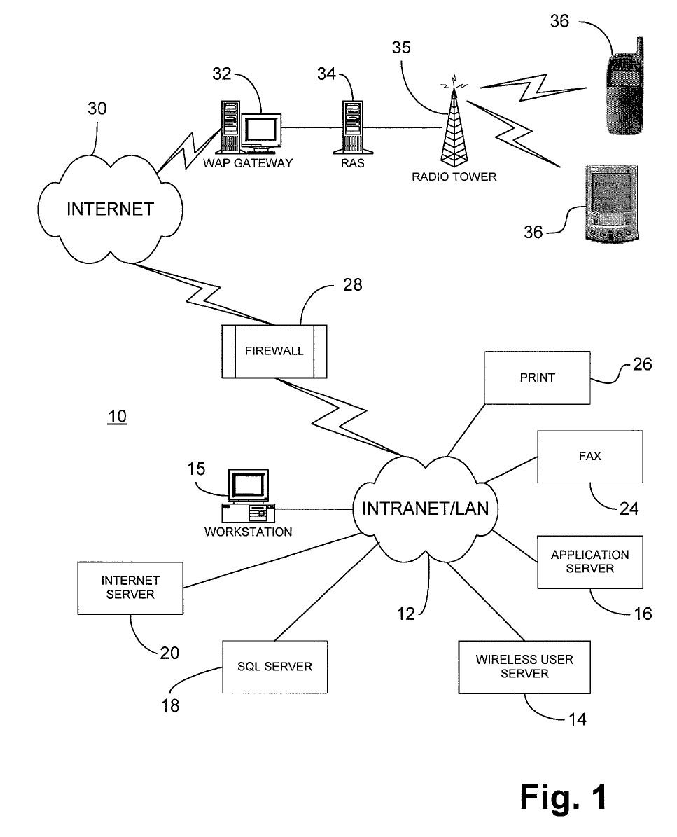

Referring now to FIG. 1, interconnection between various components of a wireless information exchange system 10 according to the present invention is shown. System 10 preferably includes an organization intranet/LAN 12, which provides information services for users within the organization. Users may be directly connected to organization intranet/LAN 12 through a workstation 15, for example. Workstation 15 preferably acts as a client for accessing server based information and applications. A wireless user server 14 preferably is connected to intranet/LAN 12 for providing access to wireless enabled information according to the present invention. An application server 16 preferably provides access to applications such as, for example, messaging applications, word processing applications, or presentation applications. An SQL server 18 provides a database engine and data storage for users and applications accessing intranet/LAN 12. An Internet server 20 provides Internet services for formatting, sending and receiving information on an Internet 30.

Intranet/LAN 12 provides connections to permit sharing of facsimile and print resources through fax service 24 and print service 26. Intranet/LAN 12 is also connected to external systems, such as Internet 30, through a secure firewall 28. Information available to intranet/LAN 12 can thus be transmitted to Internet 30, while secure information can be received by passing through firewall 28.

A WAP gateway 32 connects a RAS 34 to Internet 30 and permits WAP enabled devices 36 to receive XML formatted content, for example. Wireless devices 36 can transmit and receive information to/from a radio tower 35, which is connected to RAS 34. Accordingly, WAP enabled content can be sent and received between intranet/LAN 12 and wireless devices 36.

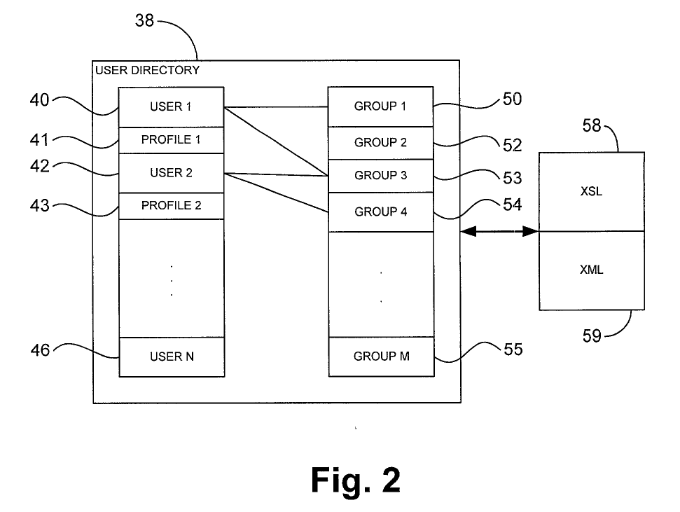

Referring now to FIG. 2, user settings and information access permissions are illustrated. Various users, i.e., users 40 and 42, each have a profile 41 and 43, respectively. Profiles 41 and 43 define individual settings and preferences for users 40 and 42 respectively. For example, user 40 may set a particular wireless device description in profile 41.

Users 40 and 42 preferably belong to various groups 50-55, depending on application and information access needs. For example, user 40 is shown as being a member of groups 50 and 53, while user 42 is shown as being a member of groups 53 and 54. Users 40 and 42 both have permissions and access to information defined for group 53, while neither have permissions or access to group 52.

Profiles 41 and 43, together with membership in groups 50-55, determine the wireless content and information format available to users 40 and 42, respectively. User setting determine information format through an extensible Script Language (XSL) 58, which is used to derive XML 59 for the presentation of user information on wireless devices 36. Settings in profiles 41, 43 and 46, coupled with access permissions defined by membership in groups 50-55, determine the parameters of XSL 58, and thus the inclusion and formatting of XML 59.

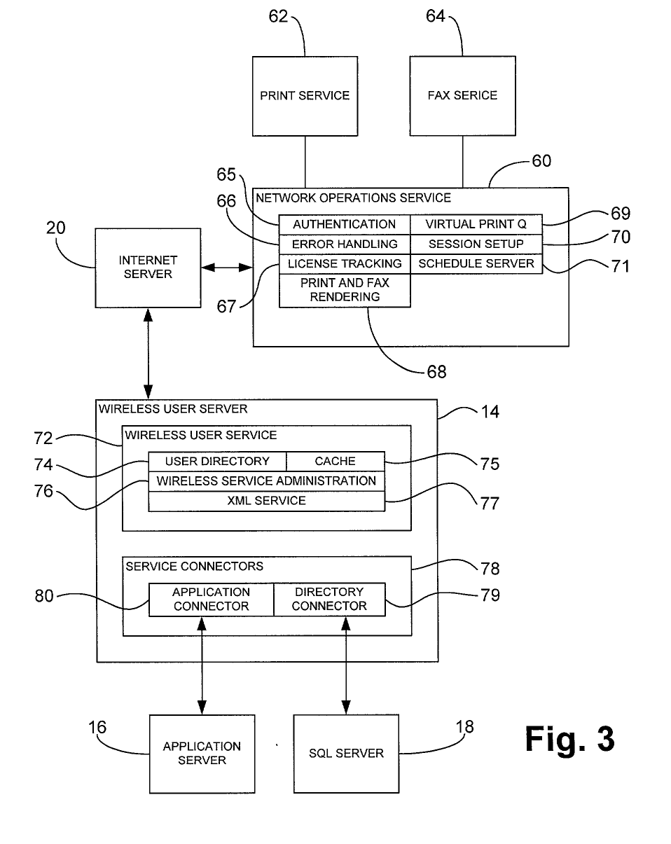

Referring now to FIG. 3, a conceptual structure of system 10 according to the present invention is shown. Wireless user server 14 is shown broken into components of a wireless user service 72 and a service connector 78. Wireless service 72 provides various features to achieve delivery of wireless accessible information. A user directory 74 contains the user preferences stored in profiles 41 and 43 of FIG. 2, for example. The user preferences provide settings for a user object model that permits other processes to handle information transmitted to and received form wireless devices 36 (FIG. 1) operated by a particular user. User preferences are preferably stored in SQL server 18, and organized in user directory 74 when needed.

Access to information contained in application server 16 typically requires a connection maintained between wireless user service 72 and application server 16. A single access typically begins with the establishment of a connection between wireless user service 72 and application server 16, after which desired data can be retrieved. Once the desired data is retrieved, the connection is eliminated.

The establishment and elimination of a connection can be costly in terms of performance criteria and overall system responsiveness. Accordingly, a portion of memory in a cache 75 is set aside to store a number of open connection links. When information from application server 16 is needed, wireless user service 72 simply selects a connection link from cache 75 to quickly gain access to application server 16. Once the desired information is retrieved, the connection is not closed, but simply marked as available by wireless user service 72. This scheme permits multiple data accesses with little overhead to improve overall performance.

Cache 75 also provides a storage mechanism by which large volumes of information can be sent to a wireless device 36 with a limited memory or resource availability. The information which wireless device 36 cannot receive is stored in cache 75, and transferred to wireless device 36 as the user calls for it. By caching the requested information in this way, no further processing is required to retrieve the information called for by wireless device 36. Wireless user service 72 simply transmits the preformatted data to wireless service 36 when called for from cache 75.

A wireless service administration 76 provides a tool by which user preferences and application settings may be maintained. Administration 76 permits object model settings for each user to be made, which are then stored in a user profile, such as profile 41, available on SQL server 18. Some features for which administration 76 permits settings are language, wireless device type, menus available and message templates. An administrator or the user may select various settings through administration 76 to customize their profiles.

An XML service 77 in wireless user server 72 allows information returned as a result of application service and information requests to be formatted in XML. The information obtained from SQL server 18 and the application operations from an application server 16 provide data to XML service 77, which in turn renders the date in XML format. XML service 77 uses settings in an XSL style sheet containing settings derived from user profiles to render XML data. The XML data is then returned to Internet server 20 for transfer to wireless device 36.

Wireless user server 14 also preferably includes service connector 78, which includes an application connector 80 and a directory connector 79. Connectors 79 and 80 provide a standard interface for connection to SQL server 18 and application server 16, while processing data in a format suitable for use by wireless user service 72. According to this scheme, wireless user server 14 becomes much more flexible in terms of installation setup, and for system upgrades. For example, if a new version or upgrade of SQL server 18 is installed, directory connector 79 still provides the same standard interface to SQL server 18, thus permitting seamless integration.

Internet server 20 provides an interface between wireless devices 36 and wireless user server 14. Wireless user server 14 transfers XML data to Internet server 20 for transmission to WAP enabled wireless devices 36 in a Wireless Markup Language (WML) format, for instance. Internet server 20 also communicates network operations related information to a network operations service 60.

Network operations service 60 handles tasks related to normal network services such as, for example, authentication 65, error handling 66, licensing tracking 67 and print and fax rendering 68. Each of these services is used by system 10 to provide the user of wireless device 36 with additional functionality.

For example, a wireless user can request a fax or print job remotely. The request is handled by Internet server 20, which obtains any required information from wireless user server 14, and submits the job to network operations service 60. Network operations service 60 accepts job information from Internet server 20 and renders the fax or print through print and fax rendering 68. The rendered fax or print is then submitted to a virtual print queue 69, which causes the job to be properly routed to a printer service 62 or a fax service 64, which can be local or remote.

Network operations service 60 also handles a session setup 70 between Internet server 20 and wireless device 36. Session setup 70 can include security accesses and protocols for wireless devices 36 to access wireless user server 14 and Internet server 20. A schedule server 71 also provides network operations service 60 with the ability to run scheduled updates or activities based on, or instance, user preferences. For example, schedule server 71 can operate to retrieve the latest information on organization activities, or update news events selected by the user.

System 10 according to the present invention also permits the feature of load balancing when presented with large numbers of requests. According to one embodiment of the present invention, load balancing is provided on a connection oriented basis. When user preferences are cached in cache 75, system 10 preferably maintains connection oriented service with load balancing. That is, rather than distributing IP packets among various processors for handling, a user of wireless device 36 maintains a connection with one processor, through which all connection related IP packets flow. This arrangement permits increased performance through the use of cached information, without requiring connection caches for each application server 16 that is accessed.

Referring again to FIG. 1, secure connections between wireless devices 36 and intranet/LAN 12 are preferably provided. Typically, communications between wireless devices 36 and RAS 34 is encrypted according to the Global System for Mobile communications (GSM) standard. However, the communication transfer between RAS 34 and WAP gateway 32 is generally provided in plain text. To avoid security risks, a connection standard for secure communications, Wireless Transport Layer Security (WTLS), is used to provide a secure connection between RAS 34 and WAP gateway 32.

In addition, the communication between WAP gateway 32 and intranet/LAN 12 is preferably secured. A secure connection can be achieved between these components using Secure Sockets Layer (SSL) protocol. In this configuration, both intranet/LAN 12 and WAP gateway 32 use SSL. Further security for the system is provided by authentication 65 shown in FIG. 3. A successful authentication of a user creates a unique session ID that is destroyed once the session ends.

System 10 according to the present invention is also distributable. For example, several wireless user servers 14 can be operated in different locations and connected to distribute performance operations. A group of users accessing one location can receive local performance, while being able to use data at remote locations.

According to the present invention, system 10 provides full user support for applications on a wireless or mobile basis. Wireless users can send and receive e-mail, look up contacts and generally access information on application server 16. Users can manipulate data in application server 16 and SQL server 18 through wireless user server 14 to provide features such as, for example, calendar manipulation and scheduling for various users, review documents stored in cache 75 and request prints and faxes delivered to globally accessible locations.

Because system 10 permits WAP enabled information to be transferred to mobile phones, for example, a user can select a telephone number appearing in a text message for immediate dialing on the mobile phone. Users also can take advantage of support provided for personal digital signatures, including newly defined user signatures.

It should be clear that the organization of components in system 10 are presented on a conceptual basis, and many possible arrangements are available. For example, Internet server 20, SQL server 18, wireless user server 14 and application server 16 can physically reside on one machine. In addition, WAP gateway 32 can be located on an opposite side of firewall 28. Alternatively, system 10 can be configured to have wireless user server 14 located remotely, on an opposite side of firewall 28 than is shown in FIG. 1.

Although the present invention has been described in relation to particular embodiments thereof, other variations and modifications and other uses will become apparent to those skilled in the art. Accordingly, the present invention is not to be limited to the specific disclosure herein, but only the appended claims.

What is claimed is:

1. A wireless information exchange system, comprising:
a wireless device;
a network connectable to said wireless device;
an information processor connectable to said network;
said processor and said wireless device operable to exchange wireless format information through said network;
a database accessible by said processor; and
said processor can store and retrieve information in said database thereby providing said wireless device with access to database information.

2. A wireless system according to claim 1, wherein said processor is operable to convert information between a database format and a wireless format.

3. A wireless system according to claim 1, further comprising:
an application service accessible by said processor; and
said application service operable to exchange information with said processor thereby providing said wireless device with access to application information.

4. A wireless system according to claim 1, wherein said network further comprises:
a local network connected to said processor;
a firewall connected to said local network; and
a global network of interconnected computers, whereby said wireless device is globally accessible by said local network.

5. A wireless system according to claim 1, wherein said information processor maintains a directory of wireless users stored in said database.

6. A wireless system according to claim 1, further comprising:
a wireless user profile;
said wireless user profile being effective to provide settings indicative of a selectable information format for presentation of wireless format information on said wireless device.

7. A wireless system according to claim 6, wherein:
said information processor maintains a directory of wireless users stored in said database; and
said information processor permits manipulation of said wireless user profile.

8. A wireless system according to claim 1, further comprising:
a service connector connected to said information processor and said database; and
said service connector effective to provide an interface between said information processor and said database.

9. A wireless system according to claim 3, further comprising:
a service connector connected to said information processor, said database and said application service;
said service connector effective to provide an interface between said information processor and said database and an interface between said information processor and said application service.

10. A wireless system according to claim 1, wherein said network further comprises:
an operation service connected to said processor and operable to manage print service requests; and
said processor can receive a print service request from said wireless device and can submit said print service request to said operation service.

11. A wireless system according to claim 10, wherein said print service requests can be requests for printing or for faxing.

12. A wireless system according to claim 8, wherein said service connector is effective to provide an installation interface, whereby a database having a standard interface is readily connectable and useable by said processor.

13. A wireless system according to claim 1, wherein said processor further comprises a plurality of installation tools operable to permit said processor to connect to a variety of networks and a variety of databases.

14. A wireless system according to claim 13, wherein at least one of said installation tools is operable to convert a set of user accounts to a format usable by said processor.

15. A wireless system according to claim 3, wherein said application service includes at least one of a messaging service, a contact managing service and a scheduling service.

16. A wireless system according to claim 1, wherein a connection between said wireless device and said network and a connection between said network and said processor are secure connections.

17. A wireless system according to claim 3, wherein information from said application service and said database are in a non-wireless format.

18. A method of exchanging wireless information, comprising:
providing a connection between a wireless device and an information processor having access to information stored in a database;
exchanging wireless format information between said wireless device and said processor;
converting information between a database format and a wireless format; and
exchanging information between said processor and said database.

19. A method according to claim 18, further comprising:
submitting a print service request from said wireless device to said processor; and
transferring said print service request to a print service operable to manage print service requests.

20. A method according to claim 19, wherein said print service request can be a request for printing or a faxing.

21. A processor operable to execute a program code from a storage memory, said program code comprising:
a first code segment executable to provide a connection between a wireless device and an information processor having access to information stored in a database;
a second code segment executable to exchange wireless format information between said wireless device and said processor;
a third code segment executable to convert information between a database format and a wireless format; and
a fourth code segment executable to exchange information between said processor and said database.

22. A computer readable media containing a program code executable to provide a wireless information exchange, said program code comprising:
a first code segment executable to provide a connection between a wireless device and an information processor having access to information stored in a database;
a second code segment executable to exchange wireless format information between said wireless device and said processor;
a third code segment executable to convert information between a database format and a wireless format; and
a fourth code segment executable to exchange information between said processor and said database.

23. A computer network for deploying a wireless information exchange, comprising:
a wireless device;
a network connectable to said wireless device;
an information processor connectable to said network;
said processor and said wireless device operable to exchange wireless format information through said network;
a database accessible by said processor; and
said processor can store and retrieve information in said database thereby providing said wireless device with access to database information.
